(19) United States
(12) Patent Application Publication
(10) Pub. No.: US 2006/0239286 A1
(43) Pub. Date: Oct. 26, 2006

(54) Method for commonly controlling the bandwidths of a group of individual information flows

(76) Inventor: Peter Schneider, Holzkirchen (DE)

Correspondence Address: MORRISON & FOERSTER LLP, 1650 TYSONS BOULEVARD, SUITE 300, MCLEAN, VA, 22102, US

(21) Appl. No.: 10/510,763

(22) PCT Filed: Apr. 12, 2002
(86) PCT No.: PCT/EP03/04113

§ 371 Date: May 10, 2005

(51) Int. Cl. H04L 12/56

(52) U.S. Cl. 370/412

(57) ABSTRACT

The aim of the invention is to achieve a good utilization of the capacity of a transmission channel while ensuring guaranteed bandwidths for traffic flows transmitted over the transmission channel. To this end, the invention provides a method for transmitting traffic flows (1, 2, 3) over a common transmission channel (7) whose (1, 2, 3) data (A E) arrives in at least one buffer (4, 5, 6) connected upstream from the transmission channel (7). According to this method: a guaranteed bandwidth (BG 1) is determined for the transmission of packets (A E) of each traffic flow (1) over the transmission channel (7); a maximum bandwidth (B1 Max) is determined fur the transmission of packets (A E) of each traffic flow (1) over the transmission channel (7), whereby packets (D E) of a traffic flow (1), which arrive in a buffer (4) with a transmission rate less than the guaranteed bandwidth (BG 1), are chronologically transmitted over the channel (7) before the packets (ABC) of this traffic flow that arrive in buffer (4) with a transmission rate exceeding the guaranteed bandwidth (yellow, red), and; packets (ABC) of a traffic flow, which arrive in a buffer (4) with a transmission rate lower than the maximum bandwidth (B1 Max), are chronologically transmitted over the transmission channel (7) before packets (C) of the traffic flow (1) that have arrived in the buffer (4) with a transmission rate exceeding the maximum bandwidth (B1 Max) of the traffic channel in the transmission channel (7) (red).

### CLAIM FOR PRIORITY

This application claims priority to International Application No. PCT/EP02/04113 which was published in the German language on Apr. 12, 2002.

### TECHNICAL FIELD OF THE INVENTION

The invention relates to a method and device for transmitting traffic streams over a common transmission channel.

### BACKGROUND OF THE INVENTION

If a number of traffic streams (with payload data packets, for example voice or multimedia data) are to be transmitted over a common transmission channel (for example through a core net of a mobile radio network) access control in the form of distribution of the bandwidth of the common transmission channel to the traffic streams to be transmitted on this transmission channel is required. In such cases each of the traffic streams can be assigned a “guaranteed bandwidth” which is securely available to the traffic stream as a proportion of the bandwidth of the transmission channel independently of traffic load in the other traffic streams. Furthermore, what is referred to as a maximum bandwidth can be defined, which is greater than the guaranteed bandwidth and which specifies how much bandwidth (volume of data to be transmitted per unit of time etc.) is available to this traffic stream on the common transmission channel. As a rule, the maximum bandwidth for a traffic stream is significantly greater than the bandwidth guaranteed for this traffic stream in the transmission channel.

To best utilize a common transmission channel for cost optimization purposes the greatest number of traffic streams possible (each with a guaranteed bandwidth) should as a rule be allowed for the common transmission channel, however at the same time the bandwidth guarantees of the individual traffic streams should not be violated, even if the transmission channel is overbooked and many traffic streams often attempt to utilize their maximum allowed bandwidth.

According to the 3 GPP Technical Specification 23.107 (www.http:\\www.3GPP.org) there exist for traffic streams of the traffic classes defined there “conversational” etc. as so-called QoS (Quality of Service) parameters including the “maximum bandwidth” and “guaranteed bandwidth” variable. At what are known as CORE Network GATEWAYS (CNGW) the situation can occur that for downlinks the own control streams, that is streams from an external network as seen by the UMTS core network into the UMTS core network (further in the direction of mobile terminals) the maximum bandwidth must be monitored and these streams in the direction of the core network on one or more transmission channels, which are each shared by a number of downlink streams, must be ensured the guaranteed bandwidth.

Access procedures known to the expert for allocating transmission channel bandwidth capacities to traffic streams are based for example on statistical mean values which are assumed for each traffic stream (supplemented by a security margin for cases where by chance many traffic streams simultaneously exceed the estimated mean value) or a measurement of the current load in the traffic streams to be transmitted over the transmission channel. A weighted fair queuing scheduler for the one queue per traffic stream for example ensures that each traffic stream can use at least one guaranteed bandwidth and a maximum of the maximum bandwidth assigned to it for transmitting packets over the common transmission channel. The disadvantage of this process is that this scheduler is expensive to implement and exhibits efficiency problems with a large number of traffic streams, so that realistically it can only be used for 1,000 traffic streams per transmission channel.

### SUMMARY OF THE INVENTION

The present invention allows simple and efficient transmission which is also suitable for transmitting a large number of traffic streams over a common transmission channel, which for each of the traffic streams, complies with the “guaranteed bandwidth” and still enables efficient utilization of the transmission capacity of the transmission channel. Since the invention defines (at least) three different priorities for onwards transmission over the transmission channel for incoming packets of a traffic stream and the transmission of packets of a traffic stream arriving in the buffer over the transmission channel is prioritized depending on this relative to each other with the bandwidth with which the packets arrived in the buffer, it is possible to ensure that the secured “guaranteed bandwidths” in the traffic streams are adhered to and a good utilization of the bandwidth of the transmission channel and a suitable prioritization of the packets of a traffic stream is made possible.

The method which can be implemented very simply and efficiently by comparison to the weighted fair queuing scheduler method is also especially suitable for transmission of more than 1,000 traffic channels over one transmission channel. A method in accordance with the invention can especially be used for traffic channels in the form of mobile radio channels for payload data (voice, alphanumeric data).

### BRIEF DESCRIPTION OF THE DRAWINGS

Further features and advantages of the invention emanate from the subsequent description of an exemplary embodiment on the basis of the drawing. The Figures show

FIG. 1 an example of transmission of data in a number of traffic streams over a common transmission channel and

FIG. 2 a schematic diagram of the use of bandwidths in a transmission channel.

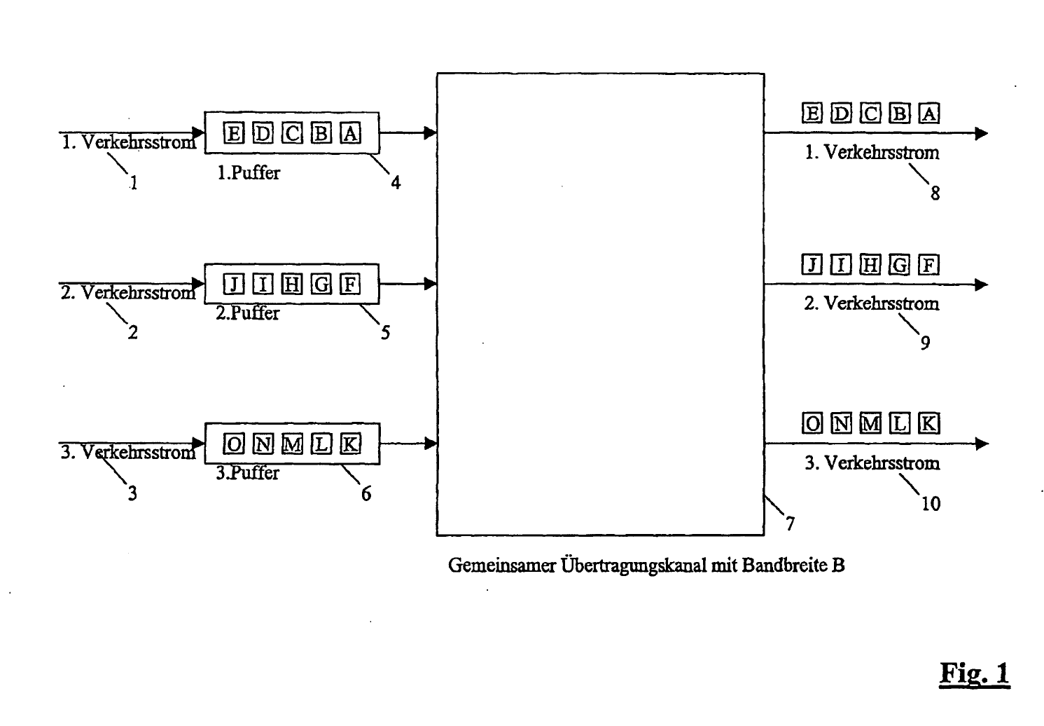

According to FIG. 1 packets A-E of a first traffic stream 1 come into a first buffer 4, data packets F-J of a second traffic stream 2 come into a second buffer 5, data packets K-O of a third traffic stream 3 come into a buffer 6, where data packets A-O are all to be transmitted via a transmission channel 7 (common for traffic streams 1-3) (for example over the core net of a mobile radio network etc.), in which case they are divided up again here after transmission over the common transmission channel 7 into a first traffic stream 8, a second traffic stream 9 and a third traffic stream 10 for separate further transmission.

The traffic stream data transferred in the packets A-E, F-J and K-U can for example be voice data of a mobile radio network or voice-related data (e-mails, Internet pages), where for example a traffic stream can transmit one or more calls in one direction. Instead of using a buffer for each traffic stream, as shown here, a common buffer can also be used for all incoming traffic streams 1-3 in one transmission channel 7. The packets of the traffic streams should already be identified in the buffer in such a way that they can be split up again beyond the buffer into the individual traffic streams 8-10.

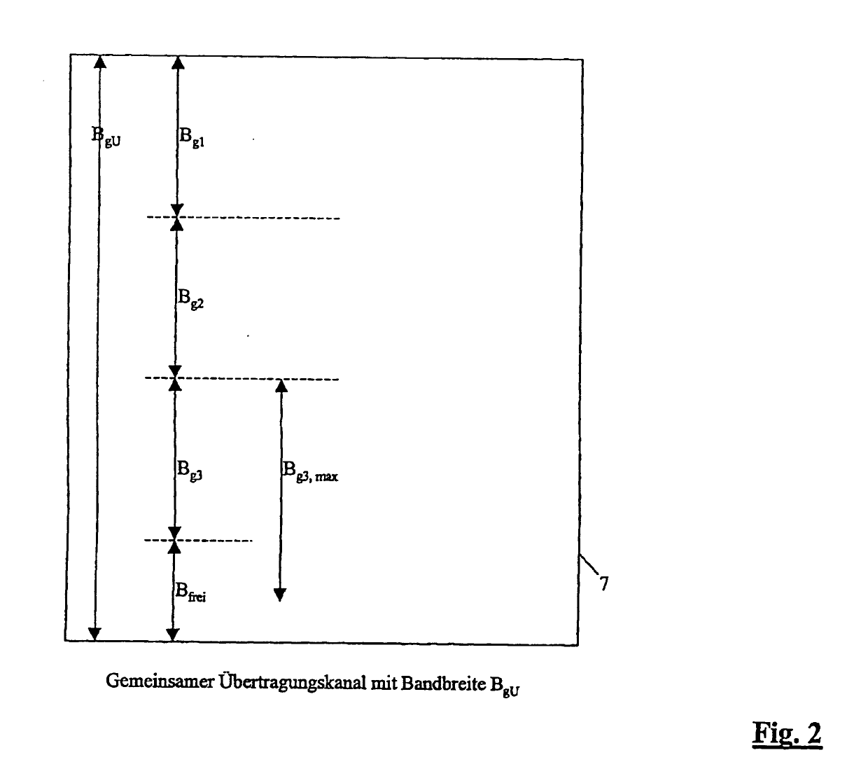

Before explaining the inventive sequence of the transmission of packets 4-6 in the common transmission channel 7, FIG. 2 is used to show the subdivision of the available bandwidth of the transmission channel B_{gU} into guaranteed bandwidths B_{G1}, B_{G2}, B_{G3} for the individual traffic streams 1-3 in the common transmission channel 7.

FIG. 2 shows schematically the entire bandwidth available in a transmission channel B_{gU} which is divided up into a number of traffic streams 1-3. Here in the present case, traffic stream 1 is given a guaranteed bandwidth B_{G1}, traffic stream 2 a guaranteed bandwidth B_{G2} and the third traffic stream 3 a guaranteed bandwidth B_{G3}. The guaranteed bandwidth of a traffic stream is available to it regardless of the actual bandwidth used by the other traffic streams (is also guaranteed). The bandwidth actually used by a transmission channel can be greater than the guaranteed bandwidth for the channel if the sum of the guaranteed bandwidths is less than the overall bandwidth of the transmission channel or if the sum of the guaranteed bandwidths plus the bandwidth used over and above this in a traffic stream is greater than the overall bandwidth of the transmission channel and with many traffic streams in a transmission channel there is little likelihood of a violation of the bandwidth guarantees occurring. In addition to the traffic streams 1-3 already booked into a transmission channel 7 a further traffic stream is only allowed if the sum of the guaranteed bandwidths for traffic streams plus the guaranteed bandwidth requested for the new traffic stream is less than the product of a quality factor constant with the entire bandwidth of the transmission channel. Whereas with a quality factor constant=1 there is a full utilization of the transmission channel with guaranteed bandwidths (so that the maximum bandwidth of a traffic stream is no greater or only insignificantly greater than the guaranteed bandwidth of the traffic stream, with a quality factor constant<1 with bursts congestion in the buffer is cleared relatively quickly, whereas with a quality factor constant>1 there is an overbooking of the transmission channel with traffic streams, so that bandwidth guarantees may not be adhered to, but the transmission channel is statistically largely booked out.

According to the model explained on the basis of FIG. 2 each traffic stream will is assigned a guaranteed bandwidth in the transmission channel which is securely available to it, as well as a maximum bandwidth in the transmission channel which as a rule is greater than the guaranteed bandwidth. The sequence in which packets arriving in a traffic stream 1 are transmitted over the transmission channel depends on the transmission rate with which packets of a traffic stream arrive (in a buffer before the transmission channel).

This can take account of the timing gap between the packets (especially with packets of the same length) and/or how extensive the packets are (especially with packets of different lengths). The packets arriving in the buffer are given a marking which takes account of this transmission rate (input bandwidth in the buffer) of these packets (for example in a header in the packet), on the basis of which the packet is selected for transmission over the transmission channel 7, which defines the sequence of its transmission.

For example packets which arrive in the buffer 4 with a transmission rate below the bandwidth guaranteed by the transmission channel for the traffic stream are marked as “green” (or as a rule given a number in the header of the packet), packets which arrive with a transmission rate lying between the guaranteed bandwidth and the maximum bandwidth of the traffic stream are marked “amber” (or as a rule given a number in the header of the packet) and packets which arrive with a transmission rate greater than the maximum bandwidth of the traffic stream are marked “red” (or as a rule given a number in the header of the packet). A marking in packets of a traffic stream (1) thus defines the order in which the packets of this traffic stream (1) will be transmitted but not the order in which packets of another traffic stream will be transmitted.

For example if the packets A, B (and possibly numerous packets arriving before these) arrive in buffer 4 for traffic stream 1 with a transmission rate which is above the guaranteed bandwidth of the traffic stream but below the maximum bandwidth of the traffic stream 1, they are marked “amber”. Packet C arrives shortly after packet B with a transmission rate which is above the maximum bandwidth, so that this packet is marked “red”. Packets D and E arrive in the buffer with a transmission rate which is below the guaranteed bandwidth of the traffic stream 1 and are marked “green” in their header etc.

The same applies to traffic streams 2 and 3. In the case discussed here the guaranteed bandwidths for each transmission channel are adhered to for the transmission of the packets of traffic streams 1 to 3 over the common transmission channel 7 and thus the maximum bandwidths per traffic channel are still adhered to as far as possible. If, as in the case discussed here, the guaranteed bandwidths and maximum bandwidths for the three traffic streams 1 to 3 are the same size in each case, in the simplest cases one packet of each of traffic streams 2, 3 can be transmitted in turn. In this case each packet D, E (green), of a traffic stream 1 which arrives in a buffer 4 with a guaranteed bandwidth below that for this traffic stream 1 for the transmission channel 7, is timed to be transmitted into the buffer 4 before all packets A, B, C, which are marked as arriving in buffer 4 with a transmission rate lying above the guaranteed bandwidth of this traffic stream (amber, red). In addition a packet of a traffic stream which is already in the (at least one) buffer 4 and is marked as having arrived in buffer (4) with a transmission rate of between the guaranteed bandwidth and the maximum bandwidth of this traffic stream (for the transmission in the transmission channel 7), is timed to be transmitted from the buffer into transmission channel 7 before all packets C arriving in the buffer 4 (red) with a transmission rate lying above the maximum transmission rate of traffic stream 1 (for transmission in transmission channel 7) (i.e. B, D before C). In such cases all packets which have arrived with a comparable transmission rate in the buffer (all red or all amber or all green packets) are timed for transmission relative to one another in the order of their arrival.

This means that the packets of traffic stream 1 previously arrived in the buffer and stored in buffer 4 in accordance with FIG. 1 are transmitted in the following order: DEABC. The same applies to the packets of traffic streams 2, 3.

This means that, within the transmission channel 7, for example every third packet (for the bandwidth distribution present here) is filled with packets of traffic stream 1 in the order specified for these packets (D, E, A, B, C). The intervening packets are filled in accordance with the packets of traffic stream 2 and of traffic stream 3.

Before transmission over transmission channel 7 packets of a traffic stream 1 are each marked with an entry defining this traffic stream 1 (e.g. “1” in the header of the packet) and after the transmission channel are sorted again if necessary into a traffic stream, so that after the transmission channel 7 the traffic streams can again be forwarded individually.

Further is can be prespecified in the example shown here for data packets of different priority (priority-red packet, priority-amber packet priority-green packet) after how much time they are discarded in the buffer. It makes sense for packets of priority “red” to expire before packets of priority “amber” and packets of priority “amber” before packets of priority “green”.

This method provides a simple and efficient way, even with a large number of traffic streams in a transmission channel, of adhering to bandwidth guarantees and also makes a high maximum transmission rate possible.

1. A method for transmission of traffic streams over a common transmission channels, of which data comes into a buffer connected upstream of the transmission channels, comprising:
defining a guaranteed bandwidth for the transmission of packets of one of the traffic streams over the transmission channel with which is a minimum bandwidth used to transmit packets of the traffic stream over the transmission channel;
defining a maximum bandwidth for the transmission of packets of the traffic stream over the transmission channel with which the packets of the traffic stream will be transmitted over the transmission channel, where packets of the traffic stream which come into a buffer with a transmission rate lying below the guaranteed bandwidth for the traffic stream in the common transmission channel, are timed for transmission over the transmission channel before the packets of the traffic stream which come into the buffer with a transmission rate lying above the guaranteed bandwidth,
wherein packets of the traffic stream which come into a buffer with a transmission rate lying below the maximum bandwidth for the traffic stream in the transmission channel are times for transmission over the transmission channel before the packets of the traffic stream which have arrived in the buffer with a transmission rate lying above the maximum bandwidth of the traffic channel in the transmission channel.

2. The method in accordance with claim 1, wherein, if the transmission channel is occupied by a number of traffic streams, each with a guaranteed bandwidth, a further traffic stream for transmission over the common transmission channel will be allowed if a sum of the guaranteed bandwidths and the requested bandwidth of the further traffic stream is a maximum of equal to a product of a prespecified quality constant with which an overall traffic channel bandwidth available to the transmission channel.

3. The method in accordance with claim 1, wherein, the constant is equal to one.

4. The method in accordance with claim 1, wherein the constant is greater than one.

5. The method in accordance with claim 1, wherein, the constant is less than one.

6. The method in accordance with claim 1, wherein the traffic channel is a mobile radio channel for payload data.

7. The method in accordance with claim 1, wherein the traffic channel passes through a UMTS GATEWAY.

8. The method in accordance with claim 1, wherein, timing priority of a packet to be transmitted over the common transmission channel before other packets is stored in a header of the packet.

9. The method in accordance with claim 1, wherein more than 1000 traffic channels run over the transmission channel.

10. A device for executing the method in accordance with claim 1.
